(19) United States
(12) Patent Application Publication
(10) Pub. No.: US 2015/0294023 A1
(43) Pub. Date: Oct. 15, 2015

(54) SEARCHING METHOD AND SYSTEM

(71) Applicant: TENCENT TECHNOLOGY (SHENZHEN) COMPANY LIMITED, Shenzhen (CN)

(72) Inventors: Liang ZENG, Shenzhen (CN); Ningjun DOU, Shenzhen (CN); Yanjie WEN, Shenzhen (CN)

(21) Appl. No.: 14/747,821

(22) Filed: Jun. 23, 2015

Related U.S. Application Data
(63) Continuation of application No. PCT/CN2013/090272, filed on Dec. 24, 2013.

(30) Foreign Application Priority Data
Dec. 24, 2012 (CN) 201210566105.4

(51) Int. Cl. G06F 17/30; H04L 12/26

(52) U.S. Cl. CPC G06F 17/30902; H04L 43/08

(57) ABSTRACT

Various exemplary examples of the present disclosure provide a searching method and a searching system. The method includes configuring an internal cache and a disk storage; wherein the disk storage stores a search record; duplicating the search record stored in the disk storage to the internal cache; receiving a keyword inputted by a user; traversing the internal cache, and determining whether there is a matching list of the keyword in the search record stored in the internal cache; in response to a determination that there is the matching list of the keyword in the search record stored in the internal cache, obtaining, from the matching list, a search term associated with the keyword; and, displaying the search term.

### CROSS-REFERENCE TO RELATED APPLICATIONS

This application is a continuation of International Patent Application No. PCT/CN2013/090272, filed Dec. 24, 2013. This application claims the benefit of Chinese Patent Application No. 2012105661054, filed Dec. 24, 2012. The entire disclosures of each of the above applications are incorporated herein by reference.

### FIELD

The present disclosure relates to searching techniques, and more particularly, to a searching method and a searching system.

### BACKGROUND

With the rapid development of science and communication technologies, a mobile communication terminal has been widely used in people's daily life. More and more persons are accustomed to using the mobile terminal to chat and surf on the Internet.

When searching through a browser installed on the mobile terminal, after a user inputs a keyword, some browsers may display, under a search box, a search term list associated with the keyword, so that the user can search out the information required by the user. Usually, the search term list is provided by a remote server after the mobile terminal is connected to the network, such as a search engine.

### SUMMARY

According to various examples of the present disclosure, a searching method and a searching system are provided, so that a problem that the searching is inefficient when a same keyword is searched through a browser installed in a mobile terminal is solved.

According to an example of the present disclosure, a searching method is provided. The method includes:

configuring an internal cache and a disk storage; wherein the disk storage stores a search record;

duplicating the search record stored in the disk storage to the internal cache;

receiving a keyword inputted by a user;

traversing the internal cache, and determining whether there is a matching list of the keyword in the search record stored in the internal cache;

in response to a determination that there is the matching list of the keyword in the search record stored in the internal cache, obtaining, from the matching list, a search term associated with the keyword; and,

displaying the search term.

According to another example of the present disclosure, a searching system is provided. The system includes:

an internal cache, to temporarily store searching-related data;

a disk storage, to store a search record;

a duplicating module, to duplicate data between the internal cache and the disk storage;

a monitoring module, to receive a keyword inputted by a user;

traversing module, to traverse the internal cache based on the keyword received by the monitoring module, and determine whether there is a matching list of the keyword in the search record stored in the internal cache; wherein the search record is duplicated from the disk storage to the internal cache;

an obtaining module, to obtain, when the traversing module determines that there is the matching list of the keyword in the search record stored in the internal cache, from the matching list a search term associated with the keyword; and,

a displaying module, to display the search term.

According to examples of the present disclosure, the internal cache is combined with the disk storage, so that the search record of the keyword stored in the disk storage can be stored for a long period. Therefore, when the same keyword is searched, a matching list of the keyword can be quickly obtained without re-initiating a network request, and thus the time for searching the keyword is greatly reduced, the searching efficiency is improved, and the computer resources and network bandwidth resources are saved, as well.

### BRIEF DESCRIPTION OF THE DRAWINGS

Features of the present disclosure are illustrated by way of example and not limited in the following figures, in which like numerals indicate like elements, in which:

FIG. 1a is a schematic diagram illustrating a structure of a searching system according to an example of the present disclosure.

FIG. 1b is a schematic diagram illustrating a structure of a searching system according to an example of the present disclosure.

FIG. 1c is a schematic diagram illustrating a structure of a searching system according to an example of the present disclosure.

FIG. 1d is a schematic diagram illustrating a structure of a searching system according to an example of the present disclosure.

FIG. 2a is a schematic flowchart illustrating a searching method according to an example of the present disclosure.

FIG. 2b is a schematic flowchart illustrating a searching method according to an example of the present disclosure.

FIG. 3a is a schematic diagram illustrating a hardware structure of a searching system according to an example of the present disclosure.

FIG. 3b is a schematic diagram illustrating a hardware structure of a searching system according to an example of the present disclosure.

### DETAILED DESCRIPTION

Hereinafter, the present disclosure will be described in further detail with reference to the accompanying drawings and examples.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

In the conventional way of obtaining a search term list, when the user inputs a keyword in the browser, a network request is re-initiated even if the keyword has been searched in a previous searching. The remote server then traverses a database to obtain a search term list associated with the keyword, and return the search term list to the mobile terminal. In this way, the time for searching the same keyword is increased, the efficiency is reduced, and computer resources and network bandwidth resources are wasted, as well.

Currently, browsers of some mobile terminals have a history recording function, i.e., a search term list associated with a keyword is obtained after the user inputs the keyword in a browser, and is stored in a memory-level cache, so that the search term list can be directly obtained from the memory-level cache when the same keyword is inputted again. However, the memory-level cache may be cleaned if the user closes the browser within a short period, or if a memory usage frequency is too high. In this case, when the user searches a keyword which is searched before, the network request is still re-initiated, and the time for searching the same keyword is still very long.

In various examples of the present disclosure, a searching method and a searching system are provided. In the examples, an internal cache is combined with a disk storage, so that a search record of a keyword stored in the disk storage can be stored for a long period. Therefore, when the same keyword is searched, a matching list of the keyword can be quickly obtained without re-initiating a network request, and thus the time for searching the keyword is greatly reduced, the searching efficiency is improved, and the computer resources and network bandwidth resources are saved, as well.

Examples of the present disclosure may be applied to a mobile terminal, which may be implemented by a computer. The computer may be a computing device including a processor coupled to a memory storing machine readable instructions for execution by the processor to execute a method and a system of the present disclosure described later. The computer may, for example, be a device such as a personal desktop computer or a portable device, such as a laptop computer, a tablet computer, a cellular telephone, or a smart phone, etc.

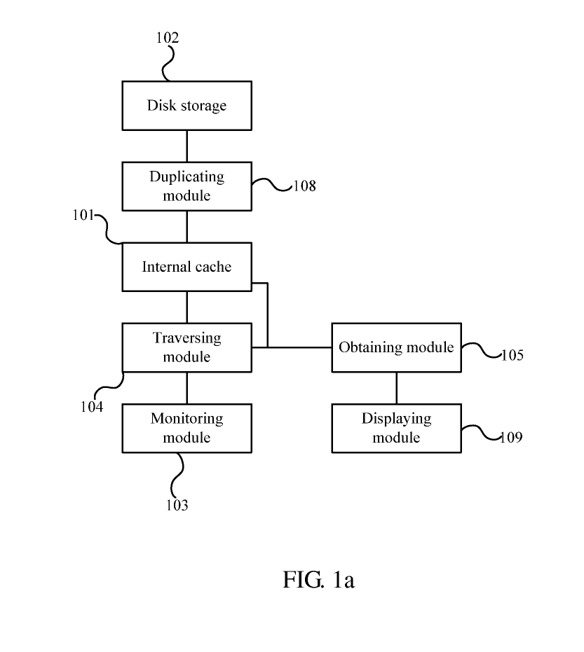

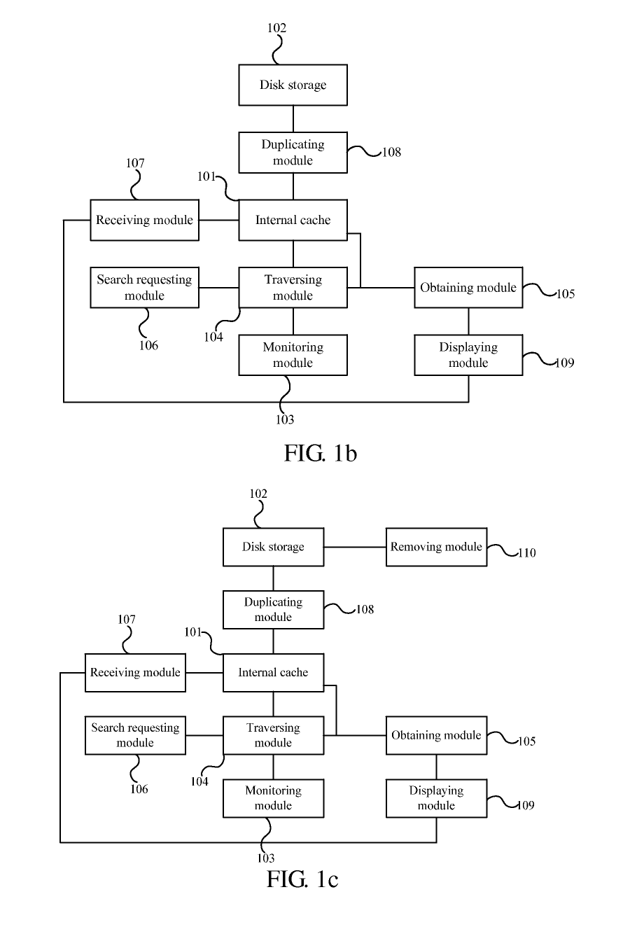

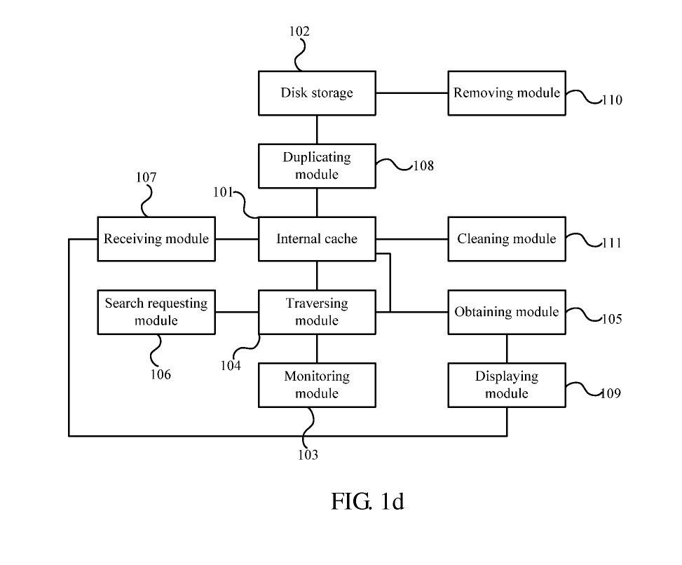

FIG. 1a is a schematic diagram illustrating a structure of a searching system according to an example of the present disclosure. FIG. 1a is a simplified diagram according to one example of the present disclosure. This diagram is an example, which should not unduly limit the scope of the claims. As shown in FIG. 1a, the system may include:

an internal cache 101, configured to temporarily store searching-related data;

a disk storage 102, configured to store a search record;

a duplicating module 108, configured to transfer and duplicate data between the internal cache and the disk storage;

a monitoring module 103, configured to receive a keyword inputted by a user;

a traversing module 104, configured to traverse the internal cache based on the keyword received by the monitoring module, and determine whether there is a matching list of the keyword in the search record stored in the internal cache; wherein the search record is duplicated from the disk storage to the internal cache;

an obtaining module 105, configured to obtain, when the traversing module determines that there is the matching list of the keyword in the search record stored in the internal cache, from the matching list a search term associated with the keyword; and,

a displaying module 109, configured to display the search term.

In an example of the present disclosure, as shown in FIG. 1b, the searching system may further include:

a search requesting module 106, configured to initiate, when the traversing module determines that there is not the matching list of the keyword in the search record stored in the internal cache, a search request about the keyword; and,

a receiving module 107, configured to receive a search result of the keyword, and storing the search result in the internal cache.

In this case, the displaying module 109 may further display a search term in the search result and associated with the keyword; and, the duplicating module 108 may further duplicate the search result from the internal cache to the search record stored in the disk storage.

In an example of the present disclosure, as shown in FIG. 1c, the searching system may further include a removing module 110, configured to remove a matching list of the keyword which is expired from the search record stored in the disk storage.

In an example of the present disclosure, as shown in FIG. 1d, the searching system may further include a cleaning module 111, configured to clean the internal cache when a searching program is closed.

FIG. 1d is a schematic diagram illustrating a structure of a searching system according to an example of the present disclosure. FIG. 1d is a simplified diagram according to one example of the present disclosure. This diagram is an example, which should not unduly limit the scope of the claims. As shown in FIG. 1d, the system may include the internal cache 101, the disk storage 102, the monitoring module 103, the traversing module 104, the obtaining module 105, the search requesting module 106, the receiving module 107, the duplicating module 108, the displaying module 109, the removing module 110, and the cleaning module 111. In this case, the internal cache 101 and the disk storage 102 are connected with each other through the duplicating module 108; the traversing module 104 is connected to the internal cache 101 and the monitoring module 103, respectively; the search requesting module 106 and the obtaining module 105 are connected with the traversing module 104; the displaying module 109 is connected to the obtaining module 105 and the receiving module 107, respectively; the removing module 110 is connected to the disk storage 102, and the cleaning module 111 is connected to the internal cache 101.

The disk storage 102 may store a search record, which is a historical search record for a keyword (i.e., a previous search record of the keyword). Of course, the search record may be manually configured by a technician based on requirements or experiences. The search record may include a matching list of the keyword, a time point for storing each search term included in the matching list, a type of the keyword, and a source of each search term included in the matching list, etc. The matching list may be defined to mean a list consisting of the keyword and a search term associated with the keyword (the search term may be a word with a similar meaning as the keyword, a word with a similar pronunciation as the keyword, or a phrase containing the keyword, etc.).

When a system program is running, the removing module 110 may traverse all search records stored in the disk storage 102, and remove a matching list of the keyword which is expired. An indication that a matching list of the keyword which is expired is removed may be defined to mean to remove a matching list of which a storing period in the disk storage 102 may exceed a deadline. The deadline may be configured based on requirements, such as one hour, one day, one week, etc. Of course, the removing of the search record in the disk storage 102 may be manually performed by a technician.

Then, the search record stored in the disk storage 102 may be duplicated to the internal cache 101 by the duplicating module 108. As a speed of a system processor for accessing the internal cache 101 is faster than a speed of the system processor for accessing the disk storage 102, the searching efficiency can be greatly improved when the search record stored in the disk storage 102 is duplicated into the internal cache 101 before starting the search.

When the search is started, the monitoring module 103 may monitor an input box area in real time. When a user inputs a keyword, a corresponding user event may be triggered. The monitoring module 103 may extract an object parameter from the user event, and thus may receive the keyword inputted.

After the keyword is received, the traversing module 104 may traverse the search record in the internal cache 101 based on the keyword inputted by the user, and determine whether there is a matching list associated with the keyword in the search record stored in the internal cache 101.

If the traversing module 104 determines that there is the matching list associated with the keyword in the search record stored in the internal cache 101, the traversing module 104 may send information that the match is successful to the obtaining module 105. The obtaining module 105 may obtain, from the matching list, a search term associated with the keyword, and send the search term to the displaying module 109. After receiving the search term associated with the keyword, the displaying module 109 may display the search term on a display (e.g., a drop-down list may be presented under the input box).

If the traversing module 104 determines that there is not the matching list associated with the keyword in the search record stored in the internal cache 101 (which may mean that the keyword is searched for a first time), the traversing module 104 may send information that the match is failed to the search requesting module 106. The search requesting module 106 may initiate a search request about the keyword. A data source of the search request initiated by the search requesting module 106 may include a local data source and a remote data source. The searching of the local data source may mean to traverse and search in a server database located in a local terminal or a local LAN (local area network). The searching of the remote data source may mean to request, through the network, a cloud server to search for the keyword, in which the remote data source may include a searching server, a video pushing server, a download pushing server, a news pushing server, a novel pushing server, and a commodity pushing server, etc.

Corresponding to the search requesting module 106, the receiving module 107 may receive a search result about the keyword, and store the search result in the internal cache 101. The search result may include a plurality of search terms associated with the keyword, a searching time point of each of the plurality of the search terms, a source of each of the plurality of the search terms, an address of the remote server, etc. Further, if the receiving module 107 receives a plurality of search results about the same keyword sent from a plurality of remote servers (i.e., the plurality of search results may come from different data sources), the receiving module 107 may store the plurality of search results in the internal cache 101, at the same time, may consolidate the search terms in different search results so as to filter out a duplicated search term and form a matching list of the keyword.

The displaying module 109 may obtain the search term associated with the keyword from the matching list of the keyword, and display the search term on the display. The duplicating module 108 may duplicate the search result in the internal cache 101 to the search record stored in the disk storage 102. As such, the search result may be directly obtained when the same keyword is searched next time.

So far, a process for searching the keyword is completed. If the user wants to search another keyword, the user may input the other keyword in the input box. When the user completes the searching and closes the system program, the cleaning module 111 may clean a storage space of the internal cache 101 to avoid great occupation of the memory.

According to examples of the present disclosure, the internal cache is combined with the disk storage, so that the search record of the keyword can be stored for a long period. Therefore, when the same keyword is searched, a matching list of the keyword can be quickly obtained without re-initiating a network request, and thus the time for searching the keyword is greatly reduced, the searching efficiency is improved, and the computer resources and network bandwidth resources are saved, as well

The above-mentioned modules may be software (e.g. machine readable instructions stored in a computer readable medium and executable by a processor), hardware (e.g. the processor of an application specific integrated circuit (ASIC)), or a combination thereof.

The above-mentioned modules in the examples of the present disclosure may be deployed either in a centralized or a distributed configuration; and may be either merged into a single module, or further split into a plurality of sub-modules.

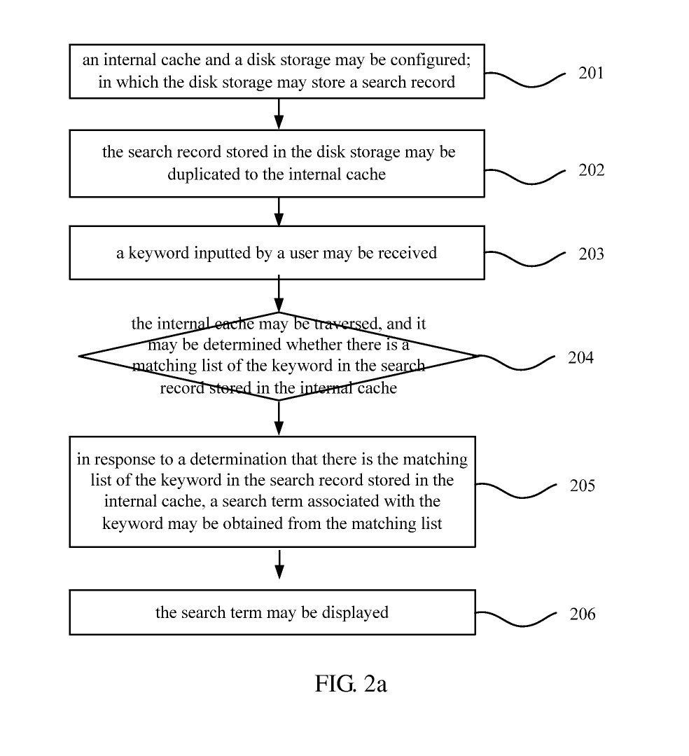

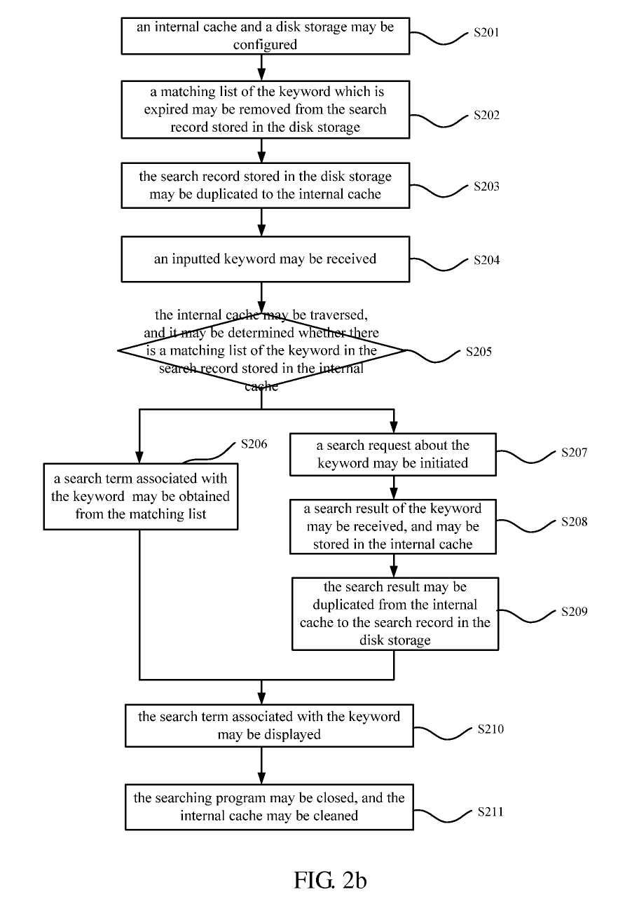

Examples of the present disclosure also provide a searching method, as shown in FIG. 2a. FIG. 2a is a simplified diagram according to one example of the present disclosure. This diagram is an example, which should not unduly limit the scope of the claims. As shown in FIG. 2a, the method may include following processes.

In block 201, an internal cache and a disk storage may be configured; in which the disk storage may store a search record;

In block 202, the search record stored in the disk storage may be duplicated to the internal cache;

In block 203, a keyword inputted by a user may be received;

In block 204, the internal cache may be traversed, and it may be determined whether there is a matching list of the keyword in the search record stored in the internal cache;

In block 205, in response to a determination that there is the matching list of the keyword in the search record stored in the internal cache, a search term associated with the keyword may be obtained from the matching list;

In block 206, the search term may be displayed.

Examples of the present disclosure may also provide a searching method, as shown in FIG. 2b. FIG. 2b is a simplified diagram according to one example of the present disclosure. This diagram is an example, which should not unduly limit the scope of the claims. As shown in FIG. 2b, the method may include following processes.

In block S201, an internal cache and a disk storage may be configured.

In this case, the disk storage may store a search record, which is a historical search record for a keyword (i.e., a previous search record of the keyword). Of course, the search record may be manually configured by a technician based on requirements or experiences. The search record may include a matching list of the keyword, a time point for storing each search term included in the matching list, a type of the keyword, and a source of each search term included in the matching list, etc. The matching list may be a list consisting of the keyword and a search term associated with the keyword (the search term may be a word with a similar meaning as the keyword, a word with a similar pronunciation as the keyword, or a phrase containing the keyword, etc.). The internal cache may temporarily store searching-related data.

In block S202, a matching list of the keyword which is expired may be removed from the search record stored in the disk storage. An indication that a matching list of the keyword which is expired is removed may be defined to mean to remove a matching list of which a storing period in the disk storage may exceed a deadline. The deadline may be configured based on requirements, such as, one hour, one day, one week, etc.

In block S203, the search record stored in the disk storage may be duplicated into the internal cache. As a speed of a system processor for accessing the internal cache is faster than a speed of the system processor for accessing the disk storage, the searching efficiency can be greatly improved when the search record stored in the disk storage is duplicated into the internal cache before starting the search.

In block S204, an inputted keyword may be received. An input box area may be monitored in real time. When the user inputs the keyword, a corresponding user event may be triggered. An object parameter may be extracted from the user event, and thus the inputted keyword may be received.

In block S205, the internal cache may be traversed, and it may be determined whether there is a matching list of the keyword in the search record stored in the internal cache. A process in block S206 may be performed in response to a determination that there is the matching list of the keyword in the search record stored in the internal cache, otherwise, a process in block S207 may be performed.

In block S206, a search term associated with the keyword may be obtained from the matching list, and a process in block S210 may be performed.

In block S207, a search request about the keyword may be initiated.

An indication that there is not the matching list associated with the keyword in the search record may be defined to mean that the keyword is searched for a first time. A data source of the search request may include a local data source and a remote data source. The searching of the local data source may mean to traverse and search in a server database located in a local terminal or a local LAN. The searching of the remote data source may mean to request, through the network, a cloud server to search for the keyword, in which the remote data source may include a searching server, a video pushing server, a download pushing server, a news pushing server, a novel pushing server, and a commodity pushing server, etc.

In block S208, a search result of the keyword may be received, and may be stored in the internal cache.

In this case, the search result may include a plurality of search terms associated with the keyword, a searching time point of each of the plurality of the search terms, a source of each of the plurality of the search terms, an address of the remote server, etc.

The search result may include a search term associated with the keyword and obtained through matching the keyword with at least one data source. In other words, if a plurality of search results about the same keyword is received from a plurality of remote servers, the plurality of search results may be stored in the internal cache, at the same time, the search terms in different search results may be consolidated so as to filter out a duplicated search term and form a matching list of the keyword.

In block S209, the search result may be duplicated from the internal cache to the search record in the disk storage. As such, the search result may be directly obtained when the same keyword is searched next time.

In block S210, the search term associated with the keyword may be displayed. For example, a drop-down list may be presented under the input box.

In block S211, the searching program may be closed, and the internal cache may be cleaned to avoid great occupation of the memory.

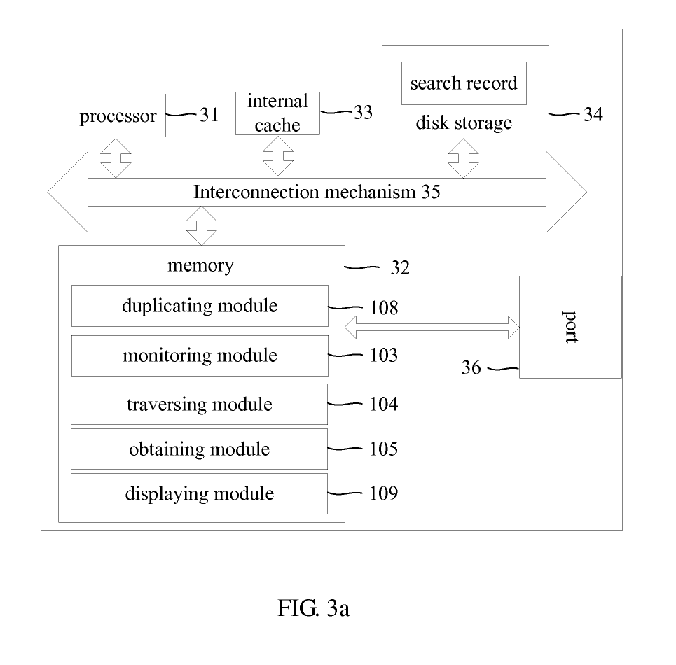

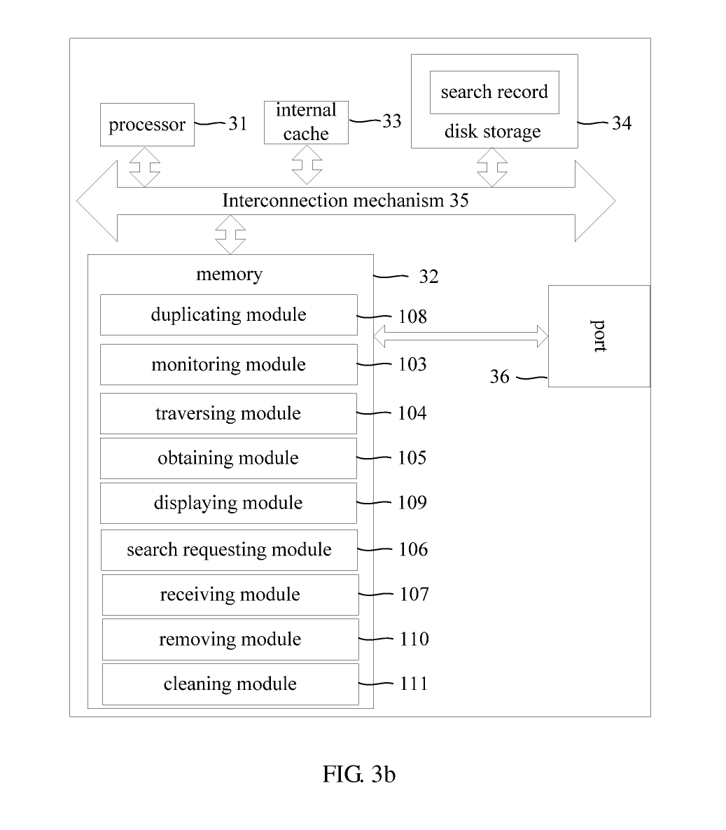

FIG. 3a is a schematic diagram illustrating a hardware structure of the searching system according to an example of the present disclosure. FIG. 3a is a simplified diagram according to one example of the present disclosure. This diagram is merely an example, which should not unduly limit the scope of the claims. As shown in FIG. 3a, the system may include a processor 31, a memory 32, an internal cache 33, a disk storage 34, an interconnection mechanism 35, and at least one port 36. In this case, the processor 31, the memory 32, the internal cache 33, and the disk storage 34 are depicted as being interconnected via the interconnection mechanism 35; and the system may transmit and receive data information through the at least one port 36.

In an example of the present disclosure, the memory 32 can store machine readable instructions, and the processor 31 can execute the machine readable instructions to store a search record in the disk storage 34; duplicate the search record stored in the disk storage 34 to the internal cache 33; receive a keyword inputted by a user; traverse the internal cache 33, and determine whether there is a matching list of the keyword in the search record stored in the internal cache 33; in response to a determination that there is the matching list of the keyword in the search record stored in the internal cache 33, obtain, from the matching list, a search term associated with the keyword; and, display the search term.

In an example of the present disclosure, the processor 31 can execute the machine readable instructions stored in the memory 32 to perform all or part of the processes described in the aforementioned method and system examples, which are not repeated herein.

As may be seen from the above description that, when the machine readable instructions stored in the memory 32 are executed by the processor 31, functions of the aforementioned internal cache 101, the disk storage 102, the monitoring module 103, the traversing module 104, the obtaining module 105, the search requesting module 106, the receiving module 107, the duplicating module 108, the displaying module 109, the removing module 110, and the cleaning module 111 may be achieved. Therefore, an example of the hardware structure of the searching system is shown in FIG. 3b.

It may be seen from the above descriptions that, according to various examples of the present disclosure, the internal cache is combined with the disk storage, so that the search record of the keyword stored in the disk storage can be stored for a long period. Therefore, when the same keyword is searched, a matching list of the keyword can be quickly obtained without re-initiating a network request, and thus the time for searching the keyword is greatly reduced, the searching efficiency is improved, and the computer resources and network bandwidth resources are saved, as well.

The above examples may be implemented by hardware, software or firmware, or a combination thereof. For example, the various methods, processes and functional modules described herein may be implemented by a processor (the term processor is to be interpreted broadly to include a CPU, processing unit, ASIC, logic unit, or programmable gate array, etc.). The processes, methods, and functional modules disclosed herein may all be performed by a single processor or split between several processors. In addition, reference in this disclosure or the claims to a ‘processor’ should thus be interpreted to mean ‘one or more processors’. The processes, methods and functional modules disclosed herein may be implemented as machine readable instructions executable by one or more processors, hardware logic circuitry of the one or more processors or a combination thereof. Further the examples disclosed herein may be implemented in the form of a computer software product. The computer software product may be stored in a non-transitory storage medium and may include a plurality of instructions for making a computer apparatus (which may be a personal computer, a server or a network apparatus such as a router, switch, access point, etc.) implement the method recited in the examples of the present disclosure.

Those skilled in the art may understand that all or part of the procedures of the methods of the above examples may be implemented by hardware modules following machine readable instructions. The machine readable instructions may be stored in a computer readable storage medium. When running, the machine readable instructions may provide the procedures of the method examples. The storage medium may be diskette, CD, ROM (Read-Only Memory) or RAM (Random Access Memory), and etc.

The figures are only illustrations of examples, in which the modules or procedures shown in the figures may not be necessarily essential for implementing the present disclosure. The modules in the aforesaid examples may be combined into one module or further divided into a plurality of sub-modules.

The above are several examples of the present disclosure, and are not used for limiting the protection scope of the present disclosure. Any modifications, equivalents, improvements, etc., made under the principle of the present disclosure should be included in the protection scope of the present disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A searching method, comprising:
configuring an internal cache and a disk storage; wherein the disk storage stores a search record;
duplicating the search record stored in the disk storage to the internal cache;
receiving a keyword inputted by a user;
traversing the internal cache, and determining whether there to is a matching list of the keyword in the search record stored in the internal cache;
in response to a determination that there is the matching list of the keyword in the search record stored in the internal cache, obtaining, from the matching list, a search term associated with the keyword; and
displaying the search term.

2. The searching method of claim 1, further comprising:
in response to a determination that there is not the matching list of the keyword in the search record stored in the internal cache, initiating a search request about the keyword;
receiving a search result of the keyword, and storing the search result in the internal cache;
duplicating the search result from the internal cache to the search record stored in the disk storage; and
displaying a search term which is in the search result and associated with the keyword.

3. The searching method of claim 2, wherein the search result comprises a search term associated with the keyword and obtained through matching the keyword with at least one data source.

4. The searching method of claim 1, further comprising:
removing a matching list of the keyword which is expired from the search record stored in the disk storage.

5. The searching method of claim 1, further comprising:
cleaning the internal cache when a searching program is closed.

6. A searching system, comprising:
an internal cache, to temporarily store searching-related data;
a disk storage, to store a search record;
a duplicating module, to duplicate data between the internal cache and the disk storage;
a monitoring module, to receive a keyword inputted by a user;
a traversing module, to traverse the internal cache based on the keyword received by the monitoring module, and determine whether there is a matching list of the keyword in the search record stored in the internal cache; wherein the search record is duplicated from the disk storage to the internal cache;
an obtaining module, to obtain, when the traversing module determines that there is the matching list of the keyword in the search record stored in the internal cache, from the matching list a search term associated with the keyword; and
a displaying module, to display the search term.

7. The searching system of claim 6, further comprising:
a search requesting module, to initiate, when the traversing module determines that there is not the matching list of the keyword in the search record stored in the internal cache, a search request about the keyword; and,
a receiving module, to receive a search result of the keyword, and storing the search result in the internal cache;
wherein the duplicating module is further to duplicate the search result from the internal cache to the search record stored in the disk storage; and
the displaying module is further to display a search term which is in the search result and associated with the keyword.

8. The searching system of claim 7, wherein the search result received by the receiving module comprises a search term associated with the keyword and obtained through matching the keyword with at least one data source.

9. The searching system of claim 6, further comprising:
a removing module, to remove a matching list of the keyword which is expired from the search record stored in the disk storage.

10. The searching system of claim 6, further comprising:
a cleaning module, to clean the internal cache when a searching program is closed.
